(19) United States
(12) Patent Application Publication
(10) Pub. No.: US 2018/0285843 A1
(43) Pub. Date: Oct. 4, 2018

(54) ELECTRONIC SYSTEM AND METHOD FOR ATM CASH WITHDRAWALS

(71) Applicant: MasterCard International Incorporated, Purchase, NY (US)

(72) Inventor: Abhishek Chaturvedi, Lucknow (IN)

(21) Appl. No.: 15/892,691

(22) Filed: Feb. 9, 2018

(30) Foreign Application Priority Data
Mar. 30, 2017 (SG) 10201702618Q

(51) Int. Cl. G06Q 20/10; G06Q 20/40

(52) U.S. Cl. CPC G06Q 20/1085; G06Q 20/401

(57) ABSTRACT

The present disclosure generally relates to an electronic system and method for cash withdrawals from automated teller machines (ATMs). The system comprises a server operative within a financial network, the server configured for performing steps of the method, comprising: receiving, by a first financial institution which the user is a customer of and from the electronic device, a user request comprising details of a selected ATM and a cash amount to be withdrawn therefrom; generating, by the first financial institution, transaction data based on details of the user request, the transaction data including authentication data; communicating the authentication data from the first financial institution to the electronic device; communicating the transaction data from the first financial institution to a second financial institution operating the selected ATM; and reserving, by the second financial institution, the cash amount in the selected ATM for a predefined time period, wherein the reserved cash amount is withdrawable from the selected ATM in response to user input of the authentication data at the selected ATM within the predefined time period.

### CROSS-REFERENCE TO RELATED APPLICATION

This application is a U.S. National Stage filing under 35 U.S.C. § 119, based on and claiming benefits of and priority to Singapore Patent Application No. 10201702618Q filed on Mar. 30, 2017. The entire disclosure of the above application is incorporated herein by reference for all purposes.

### TECHNICAL FIELD

The present disclosure generally relates to an electronic system and method for automated teller machine (ATM) cash withdrawals. More particularly, the present disclosure describes various embodiments of an electronic system and method for reserving cash in ATMs before withdrawing.

### BACKGROUND

ATMs belong to or are operated by financial institutions or banks which issue ATM cards to their users, customers, or cardholders. Each financial institution may be a member of a financial network, e.g. an interbank or ATM network. The financial network, such as Plus® and Cirrus®, enable ATM cardholders to access ATMs belonging to other financial institutions within the same financial network. A host processor or server operative within a financial network facilitates communications between the ATMs and financial institutions within the financial network.

ATMs can be found at many locations around the world and are typically used by people for cash withdrawals, among other services and functions provided by the ATMs. Conventionally, a user needs to use his/her ATM card at a particular ATM in order to perform an ATM transaction, e.g. cash withdrawal. At some locations with more human traffic, e.g. shopping malls, the cash demand at the ATMs there is high. As such, there may be frequent instances when the user finds that the ATMs do not have sufficient cash availability, i.e. the user is unable to withdraw cash. In such instances, the user would become dissatisfied, especially after standing in line or queuing for some time.

In addition, the use of ATM cards at ATMs carries some security risks or vulnerabilities to the user. For example, if the ATM is faulty, the user may find that his/her ATM card is irretrievably captured by the ATM after insertion into the card reader. The user is also required to enter a personal identification number or PIN for authenticating that the user is the true owner of the ATM card. This PIN has to be manually entered on a keypad at the ATM, which makes it vulnerable to peering eyes, especially by the person queuing behind the user for the same ATM, or by a hidden camera. Furthermore, the card reader may be maliciously fitted with a card skimmer that is able to steal information from the ATM card, compromising sensitive details of financial accounts associated with the ATM card, including the PIN.

Therefore, in order to address or alleviate at least one of the aforementioned problems and/or disadvantages, there is a need to provide an electronic system and method for cash withdrawals from ATMs, in which there is at least one improved feature over the aforementioned prior art.

### SUMMARY

According to a first aspect of the present disclosure, there is an electronic system, a method, and a non-transitory computer-readable storage medium for cash withdrawals from ATMs. The system comprises at least one server operative within a financial network, the at least one server configured for performing steps of the method or a transaction process, comprising: receiving, by a first transaction processor of a first financial institution which the user is a customer of and from the electronic device, a user request comprising details of a selected ATM and a cash amount to be withdrawn therefrom; generating, by the first transaction processor, transaction data based on details of the user request, the transaction data including authentication data; communicating the authentication data from the first transaction processor to the electronic device; communicating the transaction data from the first transaction processor to a second transaction processor of a second financial institution operating the selected ATM; and transmitting, from the first transaction processor to the second transaction processor, a request to reserve the cash amount in the selected ATM for a predefined time period, wherein the reserved cash amount is withdrawable from the selected ATM in response to user input of the authentication data at the selected ATM within the predefined time period.

According to a second aspect of the present disclosure, there is an electronic system, method, and a non-transitory computer-readable storage medium for cash withdrawals from ATMs. The system comprises a transaction processor operative within a first financial institution which the user is a customer of, the transaction processor configured for performing steps of the method or a transaction process, comprising: receiving, by the transaction processor and from the electronic device, a user request comprising details of a selected ATM and a cash amount to be withdrawn therefrom, the selected ATM operated by the first financial institution; generating, by the transaction processor, transaction data based on details of the user request, the transaction data including authentication data; communicating the authentication data from the transaction processor to the electronic device; and reserving, by the transaction processor, the cash amount in the selected ATM for a predefined time period, wherein the reserved cash amount is withdrawable from the selected ATM in response to user input of the authentication data at the selected ATM within the predefined time period.

An advantage of one or more aspects of the present disclosure is that the method ensures that the user will be able to withdraw cash from the selected ATM and will not encounter a situation where the selected ATM has insufficient cash availability, causing the user to make a wasted trip. Another advantage is that the method obviates the requirements to insert an ATM card into the card reader of the selected ATM and enter the PIN. The user can thus withdraw cash from the selected ATM without using the ATM card and without entering the PIN, thereby mitigating the security risks associated therewith.

An electronic system and method for cash withdrawals from ATMs according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an electronic system for cash withdrawals from ATMs, in accordance with a first embodiment of the present disclosure.

FIG. 2 is a general flowchart illustration of a computerized method for cash withdrawals from ATMs, in accordance with the first embodiment of the present disclosure.

FIG. 3A to FIG. 3C are detailed flowchart illustrations of a computerized method for cash withdrawals from ATMs, in accordance with the first embodiment of the present disclosure.

FIG. 4 is an illustration of an electronic system for cash withdrawals from ATMs, in accordance with a second embodiment of the present disclosure.

FIG. 5 is a general flowchart illustration of a computerized method for cash withdrawals from ATMs, in accordance with the second embodiment of the present disclosure.

FIG. 6A and FIG. 6B are detailed flowchart illustrations of a computerized method for cash withdrawals from ATMs, in accordance with the second embodiment of the present disclosure.

FIG. 7 is a block diagram illustration of the technical architecture of a server of the electronic system of FIG. 1 and FIG. 4, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. As used herein, the term “set” corresponds to or is defined as a non-empty finite organization of elements that mathematically exhibits a cardinality of at least one (e.g. a set as defined herein can correspond to a unit, singlet, or single element set, or a multiple element set), in accordance with known mathematical definitions. The recitation of a particular numerical value or value range herein is understood to include or be a recitation of an approximate numerical value or value range.

For purposes of brevity and clarity, descriptions of embodiments of the present disclosure are directed to an electronic system and method for cash withdrawals from ATMs, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

As used herein, an ATM is defined as a self-service kiosk such as a cash machine or electronic telecommunications device that enables users to perform financial transactions, particularly cash withdrawal, without the need for a human cashier, clerk or bank teller. An ATM is operated by a financial institution, ATM operator, or a bank, which also issues ATM cards to their customers or users for performing transactions at ATMs. The financial institution is typically a member of a financial network, such as an interbank network, ATM consortium, or ATM network. Some examples of financial networks include global interbank networks such as Cirrus® operated by MasterCard® and Plus® operated by Visa®.

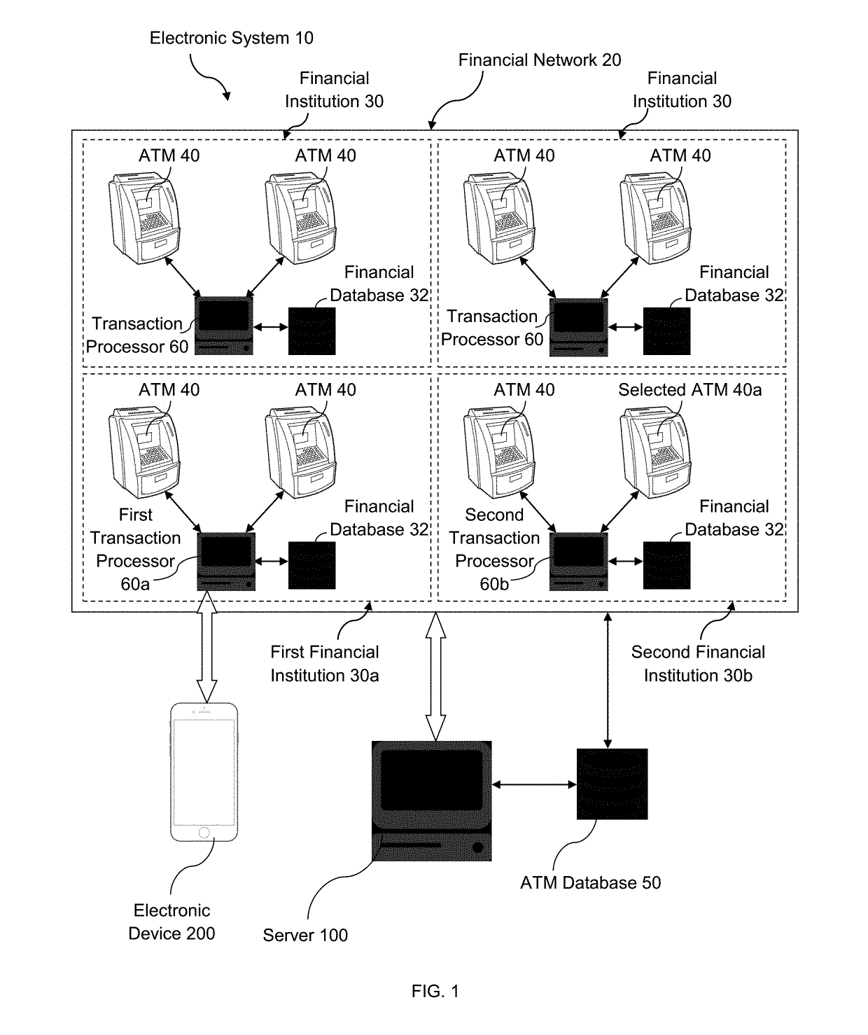

In a first representative or exemplary embodiment of the present disclosure, there is provided an electronic system 10 as illustrated in FIG. 1. The system 10 includes a financial network 20 that links together one or more financial institutions or banks 30. Each financial institution 30 issues ATM cards to users so that the users can use the ATM cards to perform transactions at various ATMs 40 belonging to or operated by the financial institutions 30 that are members of the financial network 20. The system 10 further includes a database 50 of the ATMs 40 which contains details, e.g. location and transaction records, of the ATMs 40 operated by the financial institutions 30 within the financial network 20. Transactions performed at the ATMs, e.g. cash withdrawals, are recorded on the ATM database 50. The transactions may additionally be recorded on separate financial databases 32 of the respective financial institutions 30 operating the ATMs 40. For each financial institution 30, there is a transaction processor 60 for controlling operations, e.g. transaction processes, of the financial institution 30.

The system 10 includes at least one host or server 100 operative within the financial network 20 and configured for facilitating communications among the financial institutions 30 within the financial network 20. More particularly, the server 100 is operative independently from the financial institutions 30, e.g. as one or part of a computing system for an interbank or ATM network, for facilitating communication, for example, between a first transaction processor 60a of a first financial institution 30a and a second transaction processor 60b of a second financial institution 30b. The server 100 is communicatively linked to the financial network 20 such that it forms part of or is integrally connected within the financial network 20. It will be appreciated that communications to and from each financial institution 30 occur via the respective transaction processors 60 of the financial institutions 30, and each transaction processor 60 may have a technical architecture similar or analogous to that of the server 100.

The system 10 further includes an electronic device 200 belonging to or operated by a user. The electronic device 200 may be used by the user for performing a cash withdrawal transaction with an ATM 40. The electronic device 200 may be a mobile device such as mobile phones, smartphones, personal digital assistants (PDAs), tablets, laptops, and/or computers. The user may execute an application, website, or any other user interface (collectively referred to as “application”) on the electronic device 200 to perform the cash withdrawal transaction. The application running on the electronic device 200 is hosted on the first transaction processor 60a of the first financial institution 30a which the user is a customer of, i.e. the application is provided by the first financial institution 30a as a customer service to the user. The user is considered to be a customer of the first financial institution 30a if he/she has opened a financial account therewith. Accordingly, the user can utilize the application on the electronic device 200 to access his/her financial account for performing the cash withdrawal transaction.

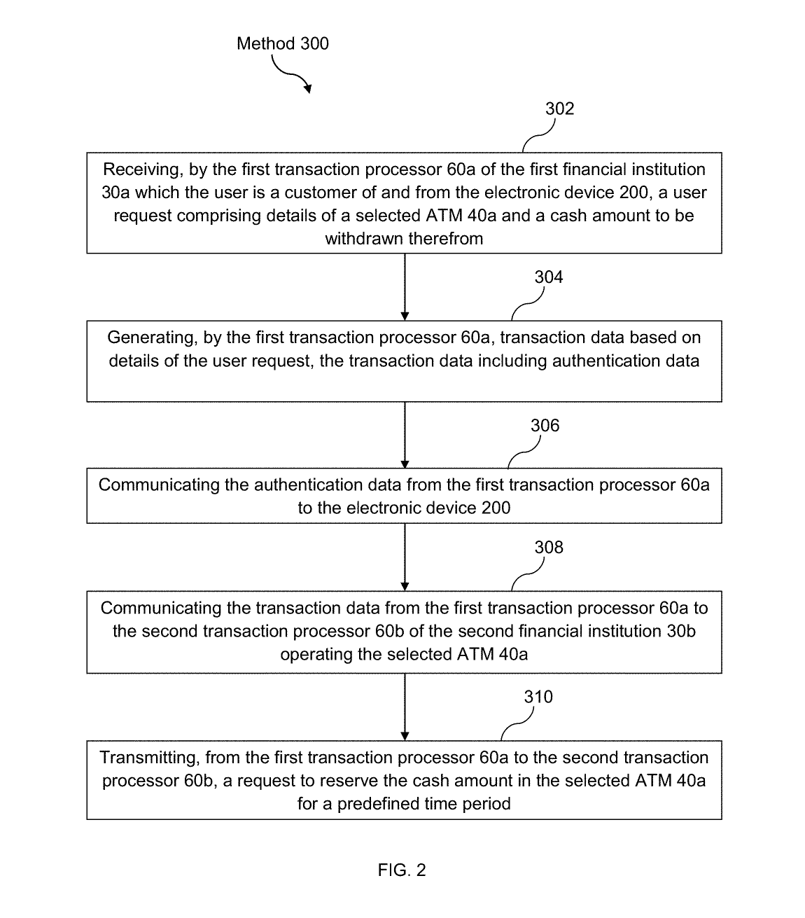

In a first embodiment with reference to FIG. 2, there is shown a computer-implemented or computerized method 300, i.e. implemented on a computer or computer system such as or comprising the at least one server 100, for cash withdrawals from the ATMs 40. The method 300 is a transaction process performed by the at least one server 100 and broadly includes:
a. a step 302 of receiving, by the first transaction processor 60a of the first financial institution 30a which the user is a customer of and from the electronic device 200, a user request comprising details of a selected ATM 40a and a cash amount to be withdrawn therefrom;
b. a step 304 of generating, by the first transaction processor 60a, transaction data based on details of the user request, the transaction data including authentication data;
c. a step 306 of communicating the authentication data from the first transaction processor 60a to the electronic device 200;
d. a step 308 of communicating the transaction data from the first transaction processor 60a to the second transaction processor 60b of the second financial institution 30b operating the selected ATM 40a; and
e. a step 310 of transmitting, from the first transaction processor 60a to the second transaction processor 60b, a request to reserve the cash amount in the selected ATM 40a for a predefined time period.

The reserved cash amount is withdrawable from the selected ATM 40a in response to user input of the authentication data at the selected ATM 40a within the predefined time period. Accordingly, the user may perform the method 300 with the electronic device 200 to reserve the cash amount that he/she intends to withdraw. The authentication data is informed to the user via the electronic device 200, so that the user can subsequently input the authentication data at the selected ATM 40a to withdraw the reserved cash amount. Firstly, the method 300 ensures that the user will be able to withdraw cash from the selected ATM 40a and will not encounter a situation where the selected ATM 40a has insufficient cash availability, causing the user to make a wasted trip. Secondly, the method 300 obviates the requirements to insert an ATM card into the card reader of the selected ATM 40a and enter a predefined PIN. The user can thus withdraw cash from the selected ATM 40a without using the ATM card and without entering the predefined PIN. Instead, the user inputs the authentication data that is generated specifically for this transaction and is valid only for the selected ATM 40a and for the predefined time period, thereby mitigating the security risks associated with conventional ATM cards and predefined PINs.

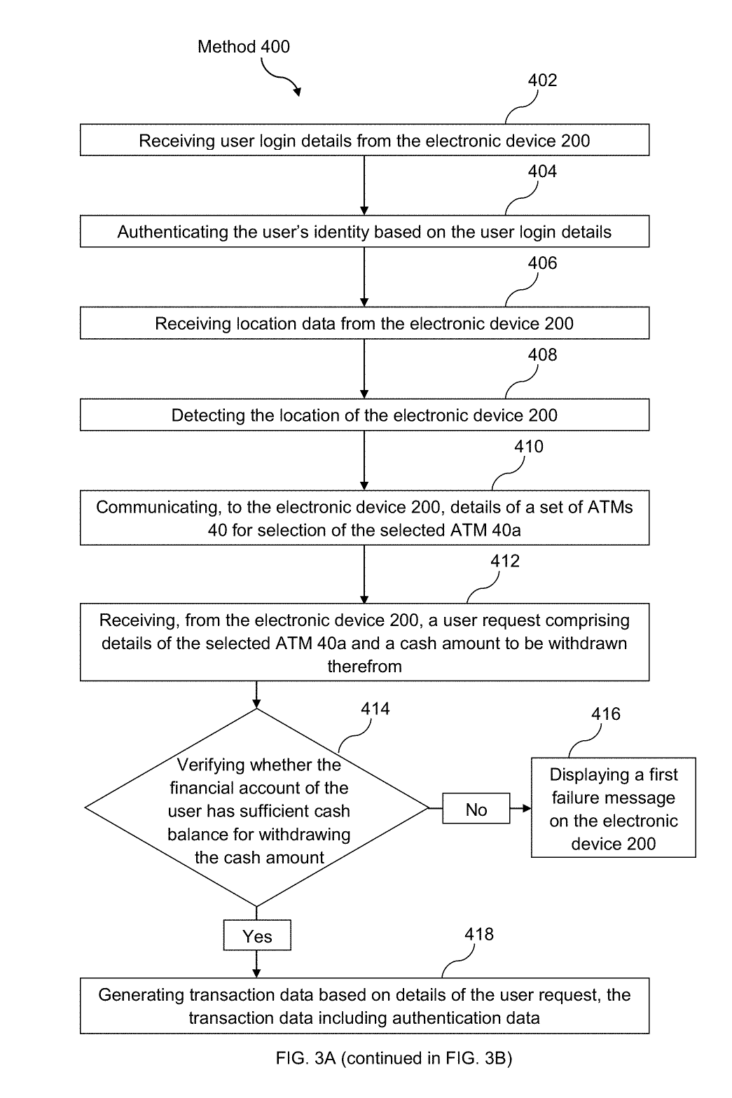

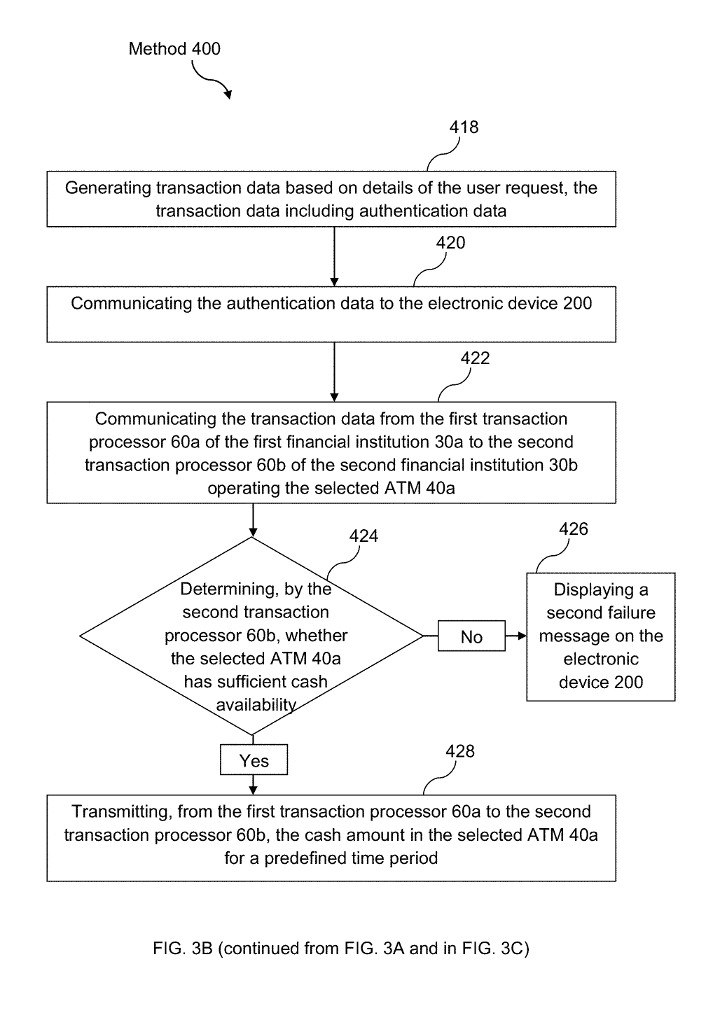

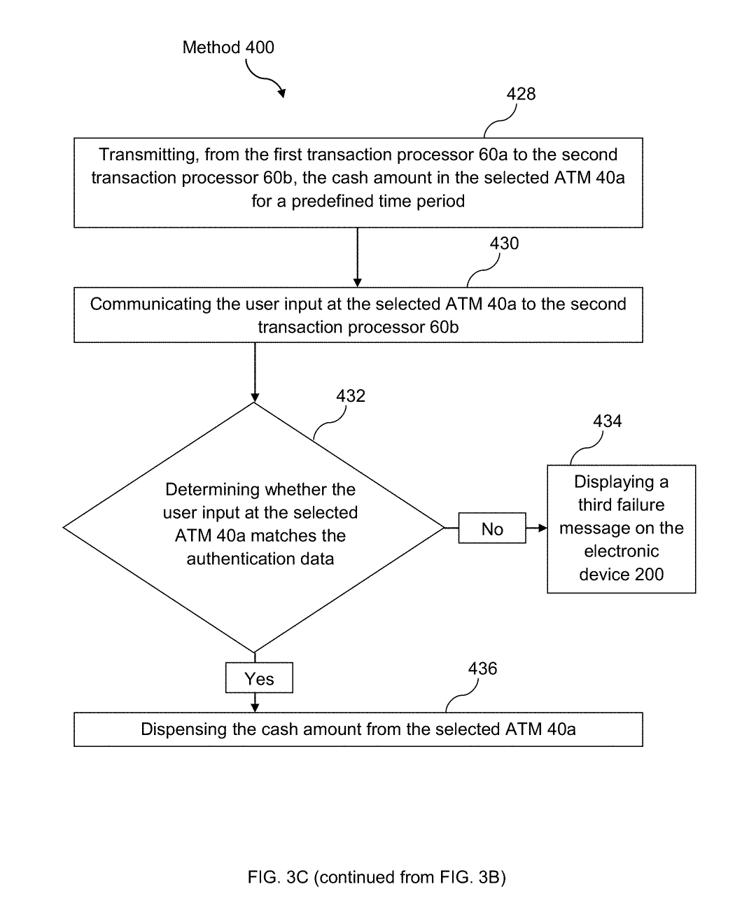

More specifically in the first embodiment, FIG. 3 shows a computerized method/transaction process 400 as a more detailed embodiment of the method/transaction process 300. The method 400 includes various steps that are performed by the at least one server 100, first transaction processor 60a of the first financial institution 30a, second transaction processor 60b of the second financial institution 30b, and electronic device 200 for cash withdrawals from the ATMs 40.

The user firstly initiates or executes the application on the electronic device 200. The method 400 includes a step 402 of receiving, by the first transaction processor 60a and from the electronic device 200, user login details for accessing the application as well as the user's financial account with the first financial institution 30a. The first financial institution 30a may also be referred to as the issuer bank. The method 400 includes a step 404 of authenticating, by the first transaction processor 60a, the user's identity based on the user login details. Accordingly, the user login details function in a similar manner as a PIN for an ATM card, enabling the first transaction processor 60a to authenticate the user for performing transactions with his/her financial account.

After the user successfully accesses the application on the electronic device 200, the first transaction processor 60a receives, in a step 406 of the method 400, location data from the electronic device 200. The location data is transmitted from a geolocation module of the electronic device 200 and enables the first transaction processor 60a, in a step 408, to detect the location of the electronic device 200 and thus of the user. The method 400 includes a step 410 of communicating, from the first transaction processor 60a to the electronic device 200, details of a set of ATMs 40 for selection of the selected ATM 40a. The set of ATMs 40 is derived or retrieved from the ATM database 50, and is determined from the location data such that each ATM 40 in the set of ATMs 40 is located within a vicinity, e.g. within a predefined radius, of the location of the electronic device 200. It will be appreciated that the predefined radius may be defined and adjusted by the user, e.g. with the application, or predefined by the first transaction processor 60a.

Optionally, the set of ATMs 40 is determined such that, in addition to the location of each ATM 40, each ATM 40 has sufficient cash availability, e.g. sufficient cash balance in the ATM 40, based on the cash amount to be withdrawn. Details on determining the cash availability of an ATM 40 is described below in a step 424 of the method 400.

The user then proceeds to select an ATM 40a from the set of ATMs 40 displayed on the electronic device 200. Alternatively, the selected ATM 40a is automatically selected from the set of ATMs 40 based on the location and cash availability thereof. The method 400 includes a step 412 of receiving, by the first transaction processor 60a and from the electronic device 200, a user request comprising details of the selected ATM 40a and a cash amount to be withdrawn therefrom. The first financial institution 30a thus becomes informed of the cash amount that the user has requested or intends to withdraw from his/her financial account. The user request may include other details such as the selection and type of financial account to withdraw from, e.g. savings or current account, and particularly if the user has multiple financial accounts with the first financial institution 30a.

The method 400 includes a step 414 of verifying, by the first transaction processor 60a, whether the financial account of the user has sufficient cash balance for withdrawing the cash amount. If the financial account has insufficient cash balance, the step 414 proceeds to a step 416 of displaying a first failure message on the electronic device 200 to inform the user that he/she will not be able to withdraw the requested cash amount. Conversely, if the financial account has sufficient cash balance, in response thereto, the step 414 proceeds to a step 418 of generating, by the first transaction processor 60a, transaction data based on details of the user request, the transaction data including authentication data.

In one example, the authentication data includes one or a number of randomly generated alphanumeric strings or sequences of characters. The random alphanumeric string may be a one-time passcode or password (OTP), e.g. a 6-digit passcode. Alternatively, the alphanumeric string is not randomly generated, but may instead be generated based on known details of the user, such as date of birth (e.g. in a DDMMYYYY format). In another example, the authentication data includes a randomly generated matrix barcode such as a QR code. In yet another example, the authentication data includes computer-readable data such as in the form of Near-Field Communication (NFC) data (or other forms of wireless communication data, e.g. Bluetooth or Wi-Fi). It will be appreciated that the authentication data may include one or more of the aforementioned examples.

The transaction data additionally includes details of the user request which may be embedded in the form of a set of alphanumeric strings. The set of alphanumeric strings includes a first alphanumeric string representing a unique identifier or identification number for the selected ATM 40a. The first alphanumeric string may be in a 6-digit format that represents the first 6 digits of the unique identification number. The set optionally includes a second alphanumeric string representing today's date when the user request is made. The second alphanumeric string may be in a DDMMYYYY format. The set optionally includes a third alphanumeric string representing the financial institution 30 that is operating the selected ATM 40a. In the first embodiment, the user holds a financial account with the first financial institution 30a and is making a withdrawal transaction with this financial account. As such, the third alphanumeric string represents a unique bank code for the first financial institution 30a, and may be in a 4-digit format. The set optionally includes a fourth alphanumeric string representing, partially, the financial account of the user. The fourth alphanumeric string may be a series of digits of the financial account number, such as the last 6 digits. It will be appreciated that the transaction data may include other or additional alphanumeric strings (or in other known formats) representing other elements associated with the instant transaction, financial account, and/or user request, etc., as would be readily understood by the skilled person.

The method 400 includes a step 420 of communicating the authentication data from the first transaction processor 60a to the electronic device 200. If the authentication data is or includes a random alphanumeric string, the random alphanumeric string is displayed on the electronic device 200 in a readable format for the user. If the authentication data is or includes a random QR code, the QR code is displayed on the electronic device 200. The authentication data may alternatively be in a non-readable format for the user and may be stored on the electronic device 200 in a computer-readable format, e.g. NFC data.

The method 400 includes a step 422 of communicating the transaction data from the first transaction processor 60a of the first financial institution 30a to the second transaction processor 60b of the second financial institution 30b operating the selected ATM 40a. The second financial institution 30b may also be referred to as the acquirer bank. As the first transaction processor 60a and second transaction processor 60b reside in the financial network 20 wherein the server 100 is operative, the server 100 facilitates the communication between them within the financial network 20. Accordingly, in the step 422, the transaction data is communicated from the first transaction processor 60a to the server 100 and subsequently to the second transaction processor 60b. In one example, the transaction data including the authentication data is communicated to the server 100 and second transaction processor 60b. In another example, the transaction data including the authentication data is communicated to the server 100 and the authentication data is held at the server 100, such that the second transaction processor 60b receives transaction data excluding the authentication data. The step 422 thus informs the second financial institution 30b about the user request (communicated to the first transaction processor 60a of the first financial institution 30a in the step 412) and that the user intends to withdraw the requested cash amount from the selected ATM 40a of the second financial institution 30b. The steps 420 and 422 may occur sequentially or simultaneously.

The method 400 includes a step 424 of determining, by the second transaction processor 60b, whether the selected ATM 40a has sufficient cash availability. If the selected ATM 40a has insufficient cash availability, the step 424 proceeds to a step 426 of displaying a second failure message on the electronic device 200 to inform the user that he/she will not be able to withdraw the requested cash amount from the selected ATM 40a. Specifically, the second failure message is communicated sequentially from the second transaction processor 60b to the server 100, the first transaction processor 60a, and subsequently to the electronic device 200. The failed cash withdrawal transaction may be recorded on the financial database 32 of the first financial institution 30a. Conversely, if the selected ATM 40a has sufficient cash availability, in response thereto, the step 424 proceeds to a step 428 of transmitting or communicating, from the first transaction processor 60a to the second transaction processor 60b, a request to reserve the cash amount in the selected ATM 40a for a predefined time period.

The cash amount is reserved in the selected ATM 40a for the predefined time period which may be determined based on business agreements or contracts between the first financial institution 30a and second financial institution 30b. The predefined time period may thus be defined by the first financial institution 30a and/or second financial institution 30b. For example, the predefined time period is 2 hours which is normally sufficient as cash withdrawal is typically an ad hoc decision and the user will want to withdraw the cash amount from the selected ATM 40a that is nearby. The cash amount is reserved in the selected ATM 40a for 2 hours and must be withdrawn from the selected ATM 40a within the 2 hours. If the user does not withdraw the reserved cash amount after the 2 hours, the reservation is cancelled and the reserved cash amount is released to be reserved and/or withdrawn by other users.

In the step 424, the cash availability of the selected ATM 40a is determined based on the current cash balance in the selected ATM 40a and other reserved cash amounts in the selected ATM 40a within the predefined time period. If the current cash balance in the selected ATM 40a is less than the cash amount that is requested by the user, the selected ATM 40a will not be able to dispense the cash amount, resulting in the step 426 and the second failure message. In addition, the step 424 considers whether there are other users who have also reserved cash amounts at the same selected ATM 40a, specifically whether there are reserved cash amounts (that have not been withdrawn) at any time within the predefined time period. If the sum of the other reserved cash amounts (which are reserved earlier by other users) and the cash amount requested by the (current) user exceeds the current cash balance in the selected ATM 40a (as at the time of the user request made by the (current) user in the step 412), there is insufficient cash in the selected ATM 40a to satisfy all the users. In this situation, there is insufficient cash availability for the (current) user, resulting in the step 426 and the second failure message.

The step 428 transmits a request to reserve the cash amount in the selected ATM 40a. The reserved cash amount is withdrawable from the selected ATM 40a in response to user input of the authentication data at the selected ATM 40a within the predefined time period. At any time during the predefined time period, the user has to go to the location of the selected ATM 40a and input or enter the authentication data (communicated to the electronic device 200 of the user in the step 420) on an input interface or device of the selected ATM 40a. The user input at the selected ATM 40a is communicated to and received by the second transaction processor 60b of the second financial institution 30b (which operates the selected ATM 40a) in a step 430.

In one example, the authentication data is or includes a random alphanumeric string, the user will be able to read the random alphanumeric string on a display screen of the electronic device 200 and enter or key in the random alphanumeric string on the input interface of the selected ATM 40a. The input interface may be a keypad, number pad, or touchscreen. In another example, if the authentication data is or includes a random QR code displayed on the electronic device 200, the user inputs the QR code by presenting the electronic device 200 in front of the input interface, e.g. a visual scanner, of the selected ATM 40a. The visual scanner will be able to visually scan the QR code from the display screen of the electronic device 200. In yet another example, the authentication data is embedded in a computer-readable format, e.g. NFC data stored on an NFC component of the electronic device 200. The NFC data is communicated to the selected ATM 40a via the input device, e.g. including a corresponding NFC component, at the selected ATM 40a. The user inputs the authentication data by waving for moving the electronic device 200 in front of the input device of the selected ATM 40a. Data communication between the electronic device 200 and the selected ATM 40a occurs via NFC communication protocol, or by other wireless communication protocol, e.g. Bluetooth low energy (BLE), or Wi-Fi, depending on the type of computer-readable format of the authentication data.

The method 400 includes a step 432 of determining, by the second transaction processor 60b/server 100, whether the user input at the selected ATM 40a matches the authentication data generated by the first transaction processor 60a in the step 418. In one example wherein the second transaction processor 60b receives the transaction data including the authentication data in the step 422, the step 432 is performed by the second transaction processor 60b to determine whether the user input at the selected ATM 40a matches the authentication data. In another example wherein the second transaction processor 60b receives the transaction data excluding the authentication data in the step 422, the second transaction processor 60b communicates the user input at the selected ATM 40a to the server 100. The step 432 is performed by the server 100 to determine whether the user input at the selected ATM 40a matches the authentication data held at the server 100. The server 100 consequently communicates a result of the step 432 to the second transaction processor 60b.

If the user input does not match the authentication data, the step 432 proceeds to a step 434 of displaying a third failure message on the selected ATM 40a and the electronic device 200 to inform the user that he/she will not be able to withdraw the requested cash amount from the selected ATM 40a. The failed cash withdrawal transaction may be recorded on the financial databases 32 of the first financial institution 30a and second financial institution 30b. Conversely, if the user input matches the authentication data, the step 432 proceeds to a step 436 of dispensing the cash amount from the selected ATM 40a. The user can then take the dispensed cash amount and complete the cash withdrawal transaction at the selected ATM 40a.

Optionally, the selected ATM 40a displays the first and second alphanumeric strings representing the unique identification number for the selected ATM 40a and today's date, respectively. This helps the user to identify the selected ATM 40a and ensure that he/she is at the correct ATM 40 to withdraw the cash amount. The unique identification number for the selected ATM 40a may be informed to the user by displaying the first alphanumeric string during selection of the selected ATM 40a from the set of ATMs. Furthermore, in addition to user input of the authentication data, the second financial institution 30b may require the user to input the 4-digit bank code of the first financial institution 30a and the last 6 digits of the user's financial account with the first financial institution 30a, i.e. from the third and fourth alphanumeric strings, respectively. An instruction message may be displayed at the selected ATM 40a to inform the user on any particular format and/or sequence to input the alphanumeric strings. It will be appreciated that the bank code of the first financial institution 30a and the user's financial account number are retrievable via the application on the electronic device 200, instead of having the user to memorize them.

The first embodiment described above relates to a cash withdrawal transaction between the first financial institution 30a and the second financial institution 30b, with the server 100 functioning as an intermediary between the first transaction processor 60a and the second transaction processor 60b. The server 100 is thus operative within the financial network 20 but independently from the transaction processors 60.

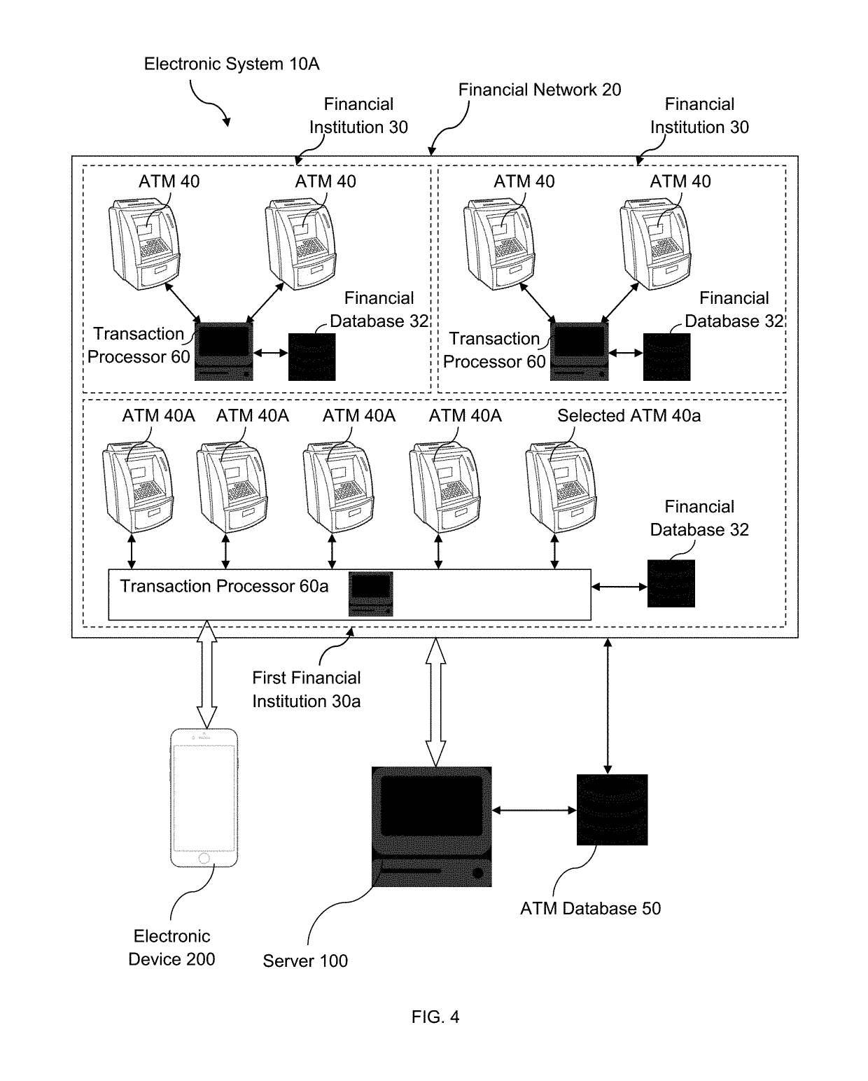

In an alternative or second representative or exemplary embodiment of the present disclosure, the cash withdrawal transaction involves only one financial institution 30—the first financial institution 30a. The user is a customer of the first financial institution 30a and the selected ATM 40 is operated by the first financial institution 30a. In the second embodiment, there is provided an electronic system 10A as illustrated in FIG. 4. The system 10A includes the financial network 20 that links together one or more financial institutions 30, including the first financial institution 30a. The system 10A further includes the ATM database 50 containing details of the ATMs 40 operated by the financial institutions 30 within the financial network 20. The first financial institution 30a operates a number of ATMs 40, collectively referred to as ATMs 40A. The transactions at the ATMs 40A may additionally be recorded on a separate financial database 32a of the first financial institution 30a.

Similar to the system 10 of the first embodiment, the system 10A of the second embodiment includes a transaction processor 60 operative within the financial network 20. More specifically, the transaction processor 60 is operative within the first financial institution 30a for controlling and operating communications and transactions associated therewith. As described above, the transaction processor 60 of the first financial institution 30a may have a technical architecture similar or analogous to that of the server 100 of the first embodiment.

The system 10A further includes the electronic device 200 which may be used by the user for performing a cash withdrawal transaction with one of the ATMs 40A. The user may execute an application on the electronic device 200 to perform the cash withdrawal transaction. The application running on the electronic device 200 is hosted on the transaction processor 60 of the first financial institution 30a which the user is a customer of. Accordingly, the user can utilize the application on the electronic device 200 to access his/her financial account for performing the cash withdrawal transaction, particularly with the ATMs 40A operated by the same first financial institution 30a.

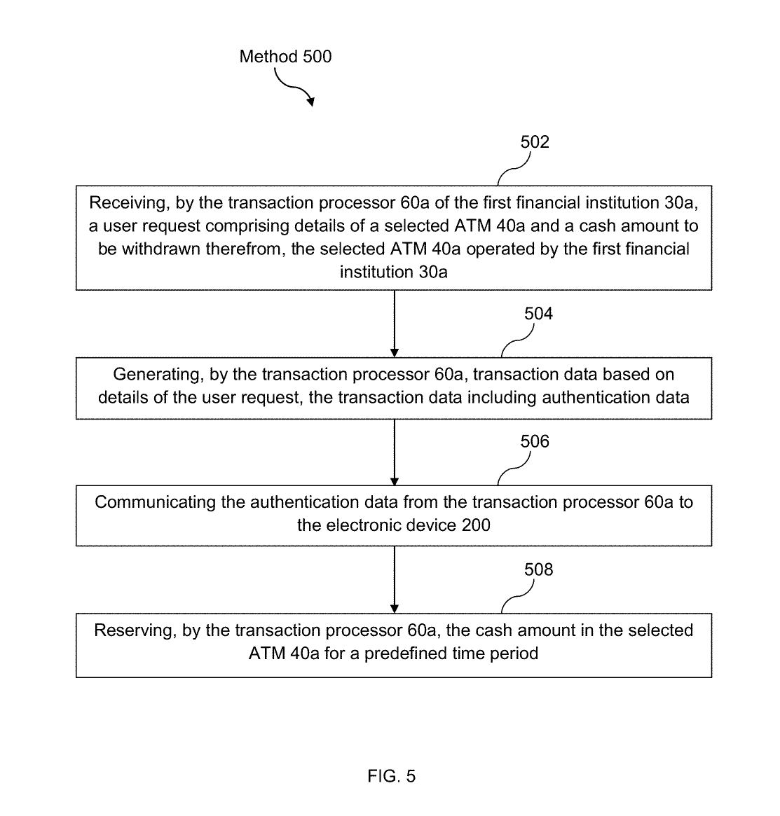

In the second embodiment with reference to FIG. 5, there is shown a computer-implemented or computerized method 500, i.e. implemented on a computer or computer system such as or comprising the transaction processor 60a of the first financial institution 30a which the user is a customer of, for cash withdrawals from the ATMs 40A. The method 500 is a transaction process performed by the transaction processor 60a and broadly includes:
a. a step 502 of receiving, by the transaction processor 60a and from the electronic device 200, a user request comprising details of a selected ATM 40a and a cash amount to be withdrawn therefrom, the selected ATM 40a operated by the first financial institution 30a;
b. a step 504 of generating, by the transaction processor 60a, transaction data based on details of the user request, the transaction data including authentication data;
c. a step 506 of communicating the authentication data from the transaction processor 60a to the electronic device 200; and
d. a step 508 of reserving, by the transaction processor 60a, the cash amount in the selected ATM 40a for a predefined time period.

The reserved cash amount is withdrawable from the selected ATM 40a in response to user input of the authentication data at the selected ATM 40a within the predefined time period. Accordingly, the user may perform the method 500 with the electronic device 200 to reserve the cash amount that he/she intends to withdraw. For purposes of brevity, it will be appreciated that advantages of the method 300 of the first embodiment are similar for the method 500 of the second embodiment.

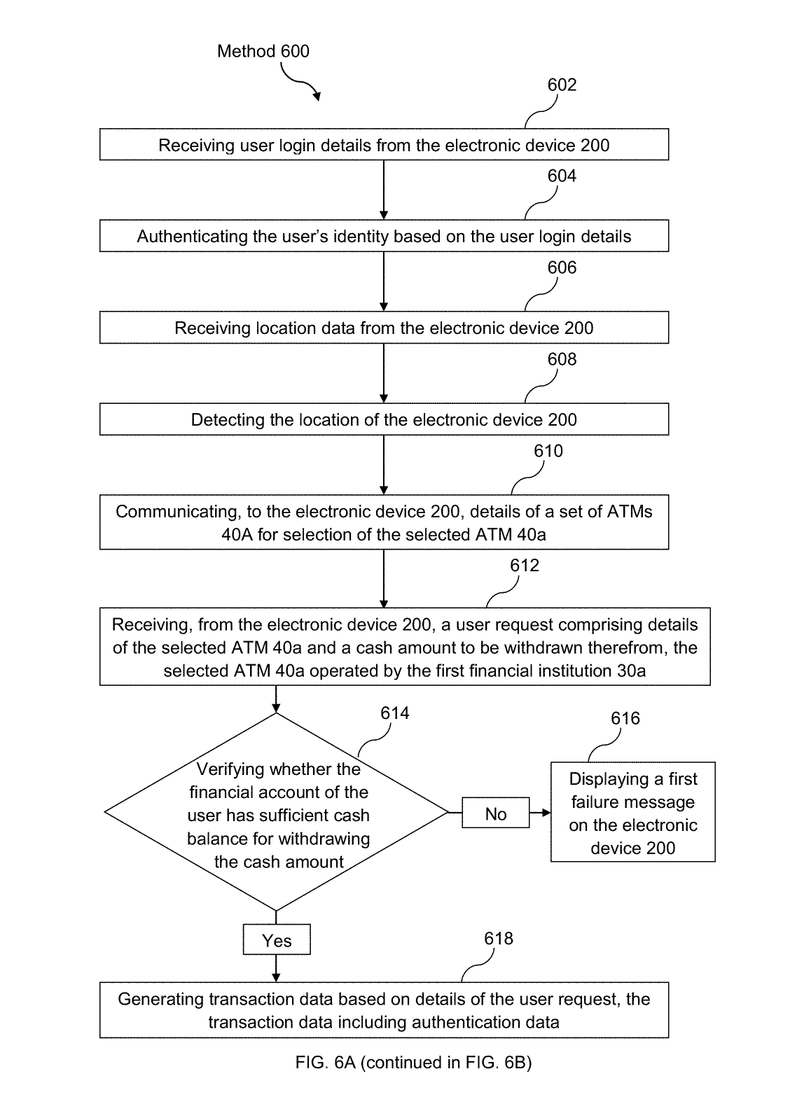

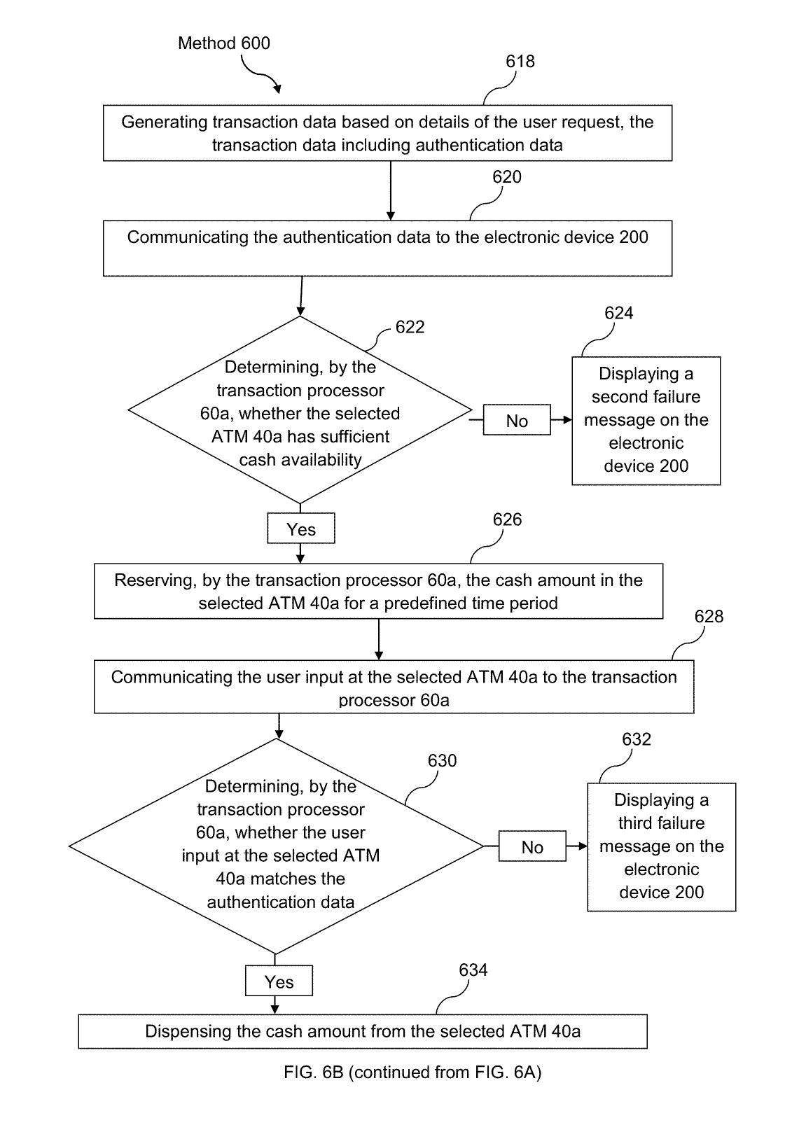

More specifically in the second embodiment, FIG. 6 shows a computerized method/transaction process 600 as a more detailed embodiment of the method/transaction process 500. The method 600 includes various steps that are performed by the transaction processor 60a and the electronic device 200 for cash withdrawals from the ATMs 40. For purposes of brevity, details on some features and optional features of the method 600 are omitted. However, it will be appreciated that features and aspects of the method 400 of the first embodiment apply similarly or analogously to the method 600 of the second embodiment. It will also be appreciated that features and aspects related to the second financial institution 30b in the method 400 will not be relevant to the method 500, as the method 500 involves only one financial institution (first financial institution 30a).

In the method 600, the user firstly initiates or executes the application on the electronic device 200. The method 600 includes a step 602 of receiving, by the transaction processor 60a (of the first financial institution 30a) and from the electronic device 200, user login details for accessing the application as well as the user's financial account with the first financial institution 30a. The method 600 includes a step 604 of authenticating, by the transaction processor 60a, the user's identity based on the user login details.

After the user successfully accesses the application on the electronic device 200, the transaction processor 60a receives, in a step 606 of the method 600, location data from the electronic device 200. The location data enables the transaction processor 60a, in a step 608, to detect the location of the electronic device 200 and thus of the user. The method 600 includes a step 610 of communicating, from the transaction processor 60a to the electronic device 200, details of a set of ATMs 40A for selection of the selected ATM 40a. The set of ATMs 40A is derived or retrieved from the ATM database 50, and is determined from the location data such that each ATM 40A is located within a vicinity of the location of the electronic device 200.

The user then proceeds to select an ATM 40a from the set of ATMs 40A displayed on the electronic device 200. Alternatively, the selected ATM 40a is automatically selected from the set of ATMs 40A based on the location and cash availability thereof. The method 600 includes a step 612 of receiving, by the transaction processor 60a and from the electronic device 200, a user request comprising details of the selected ATM 40a and a cash amount to be withdrawn therefrom, the selected ATM 40a operated by the first financial institution 30a. Accordingly, the first financial institution 30a is both the issuer and acquirer bank.

The method 600 includes a step 614 of verifying, by the transaction processor 60a, whether the financial account of the user has sufficient cash balance for withdrawing the cash amount. If the financial account has insufficient cash balance, the step 614 proceeds to a step 616 of displaying a first failure message on the electronic device 200 to inform the user that he/she will not be able to withdraw the requested cash amount. Conversely, if the financial account has sufficient cash balance, in response thereto, the step 614 proceeds to a step 618 of generating, by the transaction processor 60a, transaction data based on details of the user request, the transaction data including authentication data. The method 600 includes a step 620 of communicating the authentication data from the transaction processor 60a to the electronic device 200.

The method 600 includes a step 622 of determining, by the transaction processor 60a, whether the selected ATM 40a has sufficient cash availability. If the selected ATM 40a has insufficient cash availability, the step 622 proceeds to a step 624 of displaying a second failure message on the electronic device 200 to inform the user that he/she will not be able to withdraw the requested cash amount from the selected ATM 40a. The failed cash withdrawal transaction may be recorded on the financial database 32a of the first financial institution 30a. Conversely, if the selected ATM 40a has sufficient cash availability, in response thereto, the step 622 proceeds to a step 626 of reserving, by the transaction processor 60a, the cash amount in the selected ATM 40a for a predefined time period.

The step 626 reserves the cash amount in the selected ATM 40a. The reserved cash amount is withdrawable from the selected ATM 40a in response to user input of the authentication data at the selected ATM 40a within the predefined time period. The user input at the selected ATM 40a is communicated to and received by the transaction processor 60a in a step 628. The method 600 includes a step 630 of determining, by the transaction processor 60a, whether the user input at the selected ATM 40a matches the authentication data in the transaction data generated by the transaction processor 60a in the step 618. If the user input does not match the authentication data, the step 630 proceeds to a step 632 of displaying a third failure message on the selected ATM 40a and the electronic device 200 to inform the user that he/she will not be able to withdraw the requested cash amount from the selected ATM 40a. The failed cash withdrawal transaction may be recorded on the financial database 32a of the first financial institution 30a. Conversely, if the user input matches the authentication data, the step 630 proceeds to a step 634 of dispensing the cash amount from the selected ATM 40a. The user can then take the dispensed cash amount and complete the cash withdrawal transaction at the selected ATM 40a.

Therefore, the methods/transaction processes 300, 400, 500, and 600 described above provide a way for a user to select an ATM 40a and reserve a cash amount for a predefined time period before withdrawing subsequently within the predefined time period. The user does not need to insert his/her ATM card into the card reader and thus does not need to input or enter a PIN. The user can perform the methods 300, 400, 500, and 600 with the electronic device 200 and obtain authentication data that is generated on a per-transaction basis, and that is valid for a selected ATM 40a for a predefined time period. The reserved cash amount in the selected ATM 40a can be dispensed immediately upon user input and authentication of the authentication data. This leads to quicker processing time for each ATM transaction as the user only needs to input the authentication data and no other details, such as the requested cash amount. This consequently leads to shorter queues as less time is spent by each user at the selected ATM 40a.

Additionally, by reserving the cash amount first, the user is ensured that he/she will be able to withdraw the requested cash amount and will not make a wasted trip to the selected ATM 40a. This also leads to time savings for the user because, conventionally, the user would have to find another ATM if there is insufficient cash in one ATM.

The use of the authentication data provides for improved authentication over the conventional PIN as it is generated for every ATM transaction, as compared to the PIN which is predefined and seldom changed, and is used the same for all ATM transactions. The authentication data may be randomly generated, e.g. a random alphanumeric string or QR code, or generated based on known details of the user, e.g. date of birth. If the PIN is compromised, it could result in financial losses for the user, and even more so if the ATM card is lost. In contrast, in embodiments of the present disclosure, if the authentication data (whether generated randomly or not) is known to another person other than the user, this person does not know details of the selected ATM 40a and the predefined time period. It is thus highly unlikely that this person would be able to steal the cash amount that was reserved for the user even if the authentication data is compromised since it is only valid at the selected ATM 40a for a certain time period.

The authentication data is input or entered via an input interface or device, e.g. keypad or touchscreen, of the selected ATM 40a. In one example, only a simple keypad to function as the input interface is sufficient, particular if the authentication data is a numeric string. In another example, the input device may include a small visual scanner or NFC component for reading the authentication data from the electronic device 200. This obviates the need for a large display for at the ATMs 40 to show various options to the user, as would be conventionally. These options, e.g. requested cash amount and type of financial account, can be selected via the application on the electronic device 200 beforehand, such that the user only needs to input the authentication data at the selected ATM 40a. The display screens for the ATMs 40 can be reduced in size or even removed. This may result in a smaller size for the ATMs 40 and thus smaller spatial footprints. Alternatively, the ATMs 40 may remain the same size but due to the reduction in size or removal of the display screens, there is more space in the ATMs 40 which can be used to store larger amounts of cash.

Optionally, to enhance user experience during selection from the ATMs 40 with the application on the electronic device 200, each ATM 40 displayed on the electronic device 200 for selection is paired with a visual indicator or colour code that indicates an estimate of the cash availability or cash balance. In one embodiment, ATMs 40 having more than an upper predefined threshold amount of cash will have the visual indicator/colour code in green; ATMs 40 having less than a lower predefined threshold amount of cash will have the visual indicator/colour code in red; and ATMs 40 having cash between the lower and upper predefined threshold amounts will have the visual indicator/colour code in yellow. Users can quickly see the visual indicators/colour codes of the ATMs 40 displayed on the electronic device 200 and know which ATM 40 has sufficient cash to withdraw from before selecting the appropriate ATM 40a.

In another embodiment, the ATMs 40 are paired with different visual indications/colour codes that relate to the activity or state of the ATMs 40. For example, an ATM 40 which has been offline or inactive for some time, e.g. more than 4 days or 1 week depending on the financial institution 30 operating the ATM 40, has a white colour code. More commonly, an ATM 40 may be idle for some time, e.g. 6 hours, if it has not been used in that time, particularly if the ATM 40 is located in a remote area. The ATM 40 becomes idle if there is no activity for a predefined time period, no transactions and/or no active data communication with the ATM 40. An idle ATM 40 has a yellow colour code. If the idle ATM 40 continues to be inactive, e.g. after 4 days to 1 week, the ATM 40 is considered to be offline/inactive and the colour code changes from yellow to white. If the ATM 40 is located in a populated area where transactions frequently take place, the colour code is unlikely to be yellow or white. Instead, the ATM 40 may have a green colour code which indicates that the previous or most recent transaction at the ATM 40 is successful, i.e. a user has successfully reserved a cash amount at the ATM 40. The green colour code informs the next user that the ATM 40 likely has sufficient cash availability for reserving a cash amount. Alternatively, the ATM 40 may have a red colour code which indicates that the previous or most recent transaction at the ATM 40 is unsuccessful, i.e. a user could not reserve a cash amount at the ATM 40. The red colour informs the next user that the ATM 40 likely has insufficient cash availability.

Further optionally, statistics in relation to transactions performed with the methods 300, 400, 500, and 600 may be communicated to the at least one server 100/transaction processors 60 via the financial network 20 and recorded on a statistics database. These statistics can be used by the at least one server 100/transaction processors 60 to determine or at least estimate the rate of cash replenishments, rate of cash withdrawals, and cash balances at each ATM 40. The at least one server 100/transaction processors 60 can then develop algorithms or computational models for determining the upper and lower predefined threshold amounts for each ATM 40.

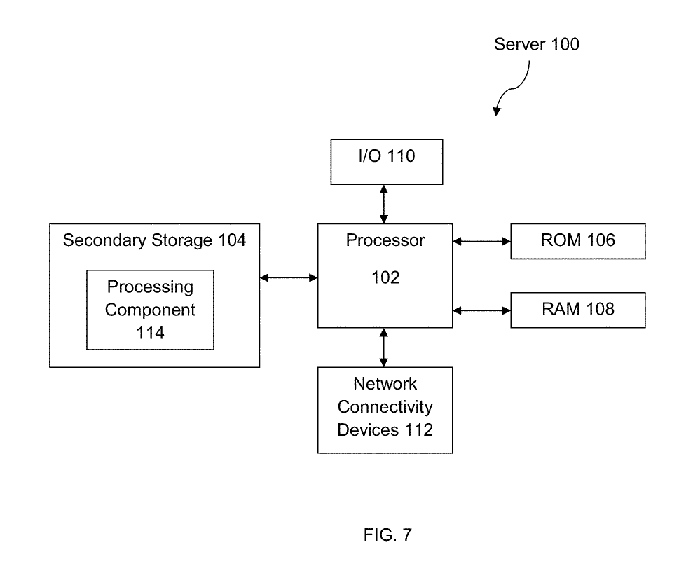

The following is a description of the technical architecture of a server 100 operative within the financial network 20 with reference to FIG. 7. It will be appreciated that the technical architecture of a transaction processor 60 operative within a financial institution 30 is similar to the technical architecture of the server 100.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300/400/500/600 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, comprising non-transitory instructions operative by the processor 102 to perform various operations or steps of the method 300/400/500/600 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 300/400/500/600. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to an electronic system and method for cash withdrawals from ATMs are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for cash withdrawals from automated teller machines (ATMs) by a user using an electronic device, the system comprising at least one server operative within a financial network, the at least one server configured for performing a transaction process comprising:
receiving, by a first transaction processor of a first financial institution which the user is a customer of and from the electronic device, a user request comprising details of a selected ATM and a cash amount to be withdrawn therefrom;
generating, by the first transaction processor, transaction data based on details of the user request, the transaction data including authentication data;
communicating the authentication data from the first transaction processor to the electronic device;
communicating the transaction data from the first transaction processor to a second transaction processor of a second financial institution operating the selected ATM; and
transmitting, from the first transaction processor to the second transaction processor, a request to reserve the cash amount in the selected ATM for a predefined time period,
wherein the reserved cash amount is withdrawable from the selected ATM in response to user input of the authentication data at the selected ATM within the predefined time period.

2. The electronic system according to claim 1, wherein the transaction process further comprises determining, by the second transaction processor, whether the selected ATM has sufficient cash availability before reserving the cash amount.

3. The electronic system according to claim 2, wherein said determining is based on current cash balance in the selected ATM and other reserved cash amounts in the selected ATM within the predefined time period.

4. The electronic system according to claim 1, wherein the transaction process further comprises verifying, by the first transaction processor, whether a financial account of the user has sufficient cash balance for withdrawing the cash amount.

5. The electronic system according to claim 4, wherein the first transaction processor generates the transaction data in response to verification that the financial account has sufficient cash balance.

6. The electronic system according to claim 1, wherein the transaction process further comprises receiving, by the first transaction processor and from the electronic device, user login details before receiving the user request.

7. The electronic system according to claim 6, wherein the transaction process further comprises authenticating, by the first transaction processor, the user's identity based on the user login details.

8. The electronic system according to claim 1, wherein the transaction process further comprises communicating, from the first transaction processor to the electronic device, details of a set of ATMs for selection of the selected ATM, each in the set of ATMs located within a vicinity of the electronic device.

9. The electronic system according to claim 8, wherein the transaction process further comprises receiving location data, by the first transaction processor, from the electronic device for determining the set of ATMs.

10. The electronic system according to claim 9, wherein each in the set of ATMs has sufficient cash availability based on the cash amount to be withdrawn.

11. The electronic system according to claim 10, wherein the selected ATM is automatically selected from the set of ATMs based on the location and cash availability thereof.

12. The electronic system according to claim 1, wherein the authentication data comprises at least one of an alphanumeric string, matrix barcode, and NFC data.

13. A computerized method implemented on at least one server for cash withdrawals from automated teller machines (ATMs) by a user using an electronic device, the at least one server being operative within a financial network, the method comprising:
receiving, by a first transaction processor of a first financial institution which the user is a customer of and from the electronic device, a user request comprising details of a selected ATM and a cash amount to be withdrawn therefrom;
generating, by the first transaction processor, transaction data based on details of the user request, the transaction data including authentication data;
communicating the authentication data from the first transaction processor to the electronic device;
communicating the transaction data from the first transaction processor to a second transaction processor of a second financial institution operating the selected ATM; and
transmitting, from the first transaction processor to the second transaction processor, a request to reserve the cash amount in the selected ATM for a predefined time period,
wherein the reserved cash amount is withdrawable from the selected ATM in response to user input of the authentication data at the selected ATM within the predefined time period.

14. The method according to claim 13, further comprising determining, by the second transaction processor, whether the selected ATM has sufficient cash availability before reserving the cash amount.

15. The method according to claim 14, wherein said determining is based on current cash balance in the selected ATM and other reserved cash amounts in the selected ATM within the predefined time period.

16. The method according to claim 13, further comprising verifying, by the first transaction processor, whether a financial account of the user has sufficient cash balance for withdrawing the cash amount.

17. The method according to claim 16, wherein the first transaction processor generates the transaction data in response to verification that the financial account has sufficient cash balance.

18. The method according to claim 13, further comprising receiving, by the first transaction processor and from the electronic device, user login details before receiving the user request.

19. The method according to claim 18, further comprising authenticating, by the first transaction processor, the user's identity based on the user login details.

20. An electronic system for cash withdrawals from automated teller machines (ATMs) by a user using an electronic device, the system comprising a transaction processor operative within a first financial institution which the user is a customer of, the transaction processor configured for performing a transaction process comprising:
receiving, by the transaction processor and from the electronic device, a user request comprising details of a selected ATM and a cash amount to be withdrawn therefrom, the selected ATM operated by the first financial institution;
generating, by the transaction processor, transaction data based on details of the user request, the transaction data including authentication data;
communicating the authentication data from the transaction processor to the electronic device; and
reserving, by the transaction processor, the cash amount in the selected ATM for a predefined time period,
wherein the reserved cash amount is withdrawable from the selected ATM in response to user input of the authentication data at the selected ATM within the predefined time period.
